(19) United States
(12) Patent Application Publication
(10) Pub. No.: US 2016/0055728 A1
(43) Pub. Date: Feb. 25, 2016

(54) SECURITY SYSTEM WITH MODULAR REGULATOR

(71) Applicant: InVue Security Products Inc., Charlotte, NC (US)

(72) Inventor: Jeffrey A. Grant, Charlotte, NC (US)

(21) Appl. No.: 14/817,655

(22) Filed: Aug. 4, 2015

Related U.S. Application Data
(60) Provisional application No. 62/040,176, filed on Aug. 21, 2014.

(51) Int. Cl. G08B 13/14

(52) U.S. Cl. CPC G08B 13/1409

(57) ABSTRACT

Embodiments of the present invention are directed to security systems for securing an item of merchandise from theft. For example, the security system may include a sensor. The security system also includes a first cable connected to the sensor and a second cable connected to the sensor and configured to removably engage the item of merchandise. In addition, the security system includes a voltage regulator configured to be removably attached to the sensor and the item of merchandise. The voltage regulator is configured to be electrically connected to each of the first and second cables and to adapt voltage provided to the item of merchandise through the second cable.

### CROSS REFERENCE TO RELATED APPLICATIONS

This application claims the benefit to priority of U.S. Provisional Patent Application No. 62/040,176 filed on Aug. 21, 2014, the entire disclosure of which is incorporated herein by reference.

### BACKGROUND OF THE INVENTION

Embodiments of the present invention relate generally to security systems for protecting items of merchandise, such as consumer electronics products, from theft and/or unauthorized removal.

It is common practice for retailers to provide demonstration models of consumer electronics products, such as handheld devices, tablets, and laptop computers, so that a potential purchaser may examine the product more closely and test the operation of its features. A working demonstration model, however, increases the possibility that the demonstration model will be stolen or removed from the display area by an unauthorized person. As a result, demonstration models of consumer electronics products are typically protected by a security system that permits a potential purchaser to examine and operate the product, while reducing the likelihood that the demonstration model will be stolen or removed from the display area.

### BRIEF SUMMARY OF THE INVENTION

Embodiments of the present invention are directed to security systems and methods for securing an item of merchandise from theft. For example, the security system may include a sensor. The security system also includes a first cable connected to the sensor and a second cable connected to the sensor and configured to removably engage the item of merchandise. In addition, the security system includes a voltage regulator configured to be removably attached to the sensor and the item of merchandise. The voltage regulator is configured to be electrically connected to each of the first and second cables and to adapt voltage provided to the item of merchandise through the second cable.

In one embodiment, a security system for securing an item of merchandise from theft is provided. The security system includes at least one sensor assembly, wherein the sensor assembly includes a sensor, a first cable connected to the sensor, and a second cable connected to the sensor and configured to removably engage the item of merchandise. The security system further includes a modular voltage regulator selected from a plurality of different modular voltage regulators, wherein each modular voltage regulator is configured to be removably attached to the sensor and the item of merchandise. The voltage regulator is configured to adapt voltage provided to the item of merchandise through the second cable

In another embodiment, a method for securing an item of merchandise from theft is provided. The method includes providing a sensor having a first cable and a second cable and attaching a voltage regulator to the sensor and the item of merchandise. The voltage regulator is configured to adapt voltage provided to the item of merchandise through the second cable. The method also includes connecting the second cable to the item of merchandise.

### BRIEF DESCRIPTION OF THE DRAWINGS

FIG. 1 is a schematic of a security system according to one embodiment of the present invention.

FIG. 2 is a schematic of a security system according to another embodiment of the present invention.

FIG. 3 is an enlarged view of the sensor and voltage adapter shown in FIGS. 1 and 2.

### DETAILED DESCRIPTION OF EMBODIMENTS OF THE INVENTION

Referring to the accompanying figures wherein identical reference numerals denote the same elements throughout the various views, the referenced figures illustrate embodiments of security systems according to the present invention for protecting an item of merchandise against theft or unauthorized removal. The item of merchandise may be any item, including any number of consumer electronics products (e.g. hand-held device, cellular phone, smart phone, tablet, laptop computer, camera, etc.). The security systems described herein are operable for securing the item of merchandise against theft or authorized removal, while at the same time permitting a potential purchaser to closely examine and operate the item of merchandise in a display area. The security system permits a potential purchaser to examine and test the item of merchandise, while reducing the likelihood that the item of merchandise will be stolen or removed from the display area by an unauthorized person. The systems shown and described herein are suitable for securing an item of merchandise in a residential or commercial environment, as well as a retail environment, and furthermore, is not intended to be limited to use only as a security display device for protecting against theft and/or unauthorized removal.

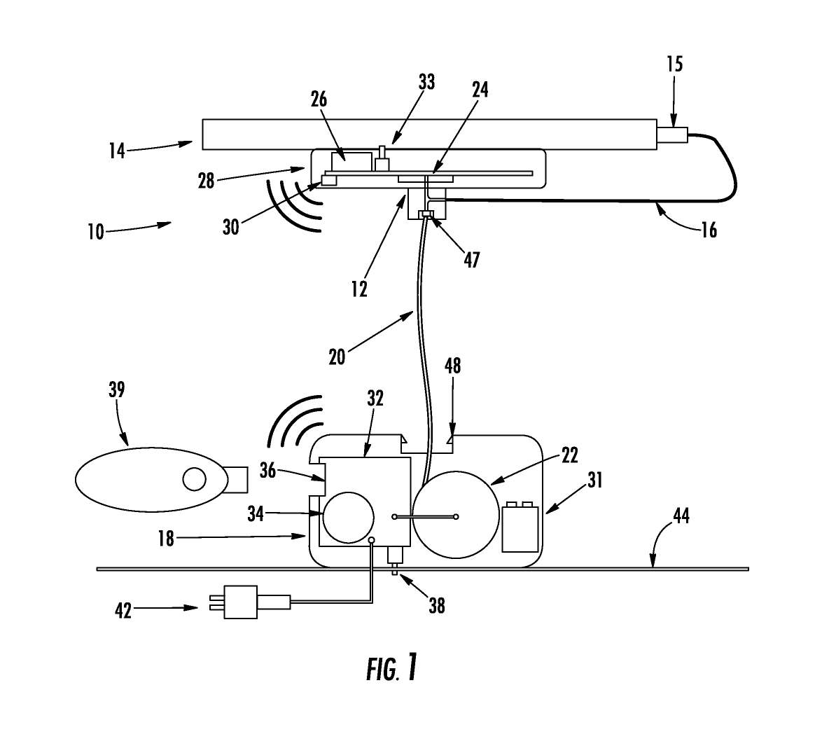

According to one embodiment shown in FIG. 1, the security system 10 generally comprises a sensor 12 configured to be coupled to an item of merchandise 14 via a voltage regulator 28. The sensor 12 may be electrically connected to an adapter cable 16 that is configured to electrically connect to the item of merchandise 14. The security system 10 may also include a base 18 that is configured to removably support the sensor 12 and the item of merchandise 14 thereon. In some embodiments, the security system 10 also includes a cable 20 that is secured to the sensor 12 at one end and operably engaged with a recoiler 22 at an opposite end. As explained in further detail below, a sense circuit or loop may be defined through the cable 20 and adapter cable 16. As such, the sense loop may be used to detect various security events associated with the cables 16, 20, such as either cable being cut, shorted, and/or disconnected. The base 18 and/or sensor 12 may be configured detect security events associated with the sensor and/or the item of merchandise 14, such as the item of merchandise being removed from the voltage regulator 28.

In one embodiment, the security system 10 includes a voltage regulator 28. The voltage regulator 28 is configured to be attached to the sensor 12 and the item of merchandise 14. The voltage regulator 28 may be secured to the item of merchandise 14 using any desired technique, such as with an adhesive, one or more fasteners, and/or mechanical brackets. As explained in further detail below, the voltage adapter 28 may be configured to adapt voltage provided to the item of merchandise 14.

In one embodiment, the sensor 12 may be electrically connected to an adapter cable 16 with a connector 15 that is configured to electrically connect to an input jack of the item of merchandise 14. In one embodiment, the adapter cable 16 may be hardwired to the sensor 12 at one end, and the connector 15 at the opposite end may be configured to be removably inserted into the input jack of the item of merchandise 14. For example, the connector 15 may be any suitable connector configured to engage a corresponding item of merchandise 14, such as a micro-USB connector, USB-C, or an Apple Lightning® connector. Thus, the sensor 12 and the item of merchandise 14 may be electrically connected via the voltage regulator 28, adapter cable 16, and connector 15. The voltage regulator 28 and/or sensor 12 may include a printed circuit board (PCB) 24, circuitry, or the like. Moreover, the voltage regulator 28 and/or sensor 12 may also include a battery or capacitor 26. In addition, the voltage regulator 28 and/or sensor 12 may include an alarm mechanism 30, such as a piezoelectric transducer, for generating an audible alarm in response to a security event. Although the term “sensor” is used herein, it is understood that the sensor 12 may simply provide a mounting member for connection to the adapter cable 16, cable 20, and voltage regulator 28. Thus, the sensor 12 may not include any circuitry and/or sensing functionality in some embodiments and may facilitate an electrical connection between the adapter cable 16, cable 20, and voltage regulator 28.

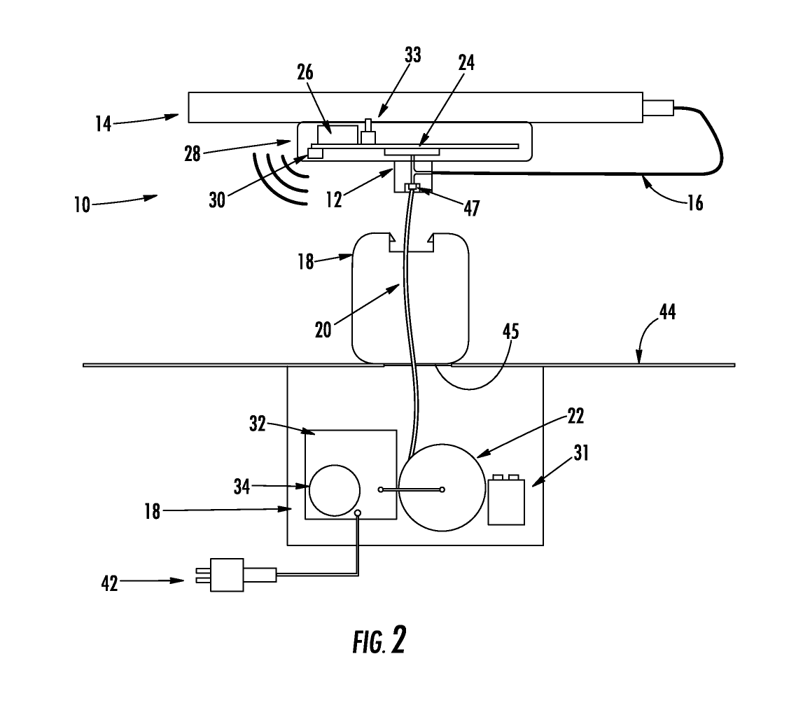

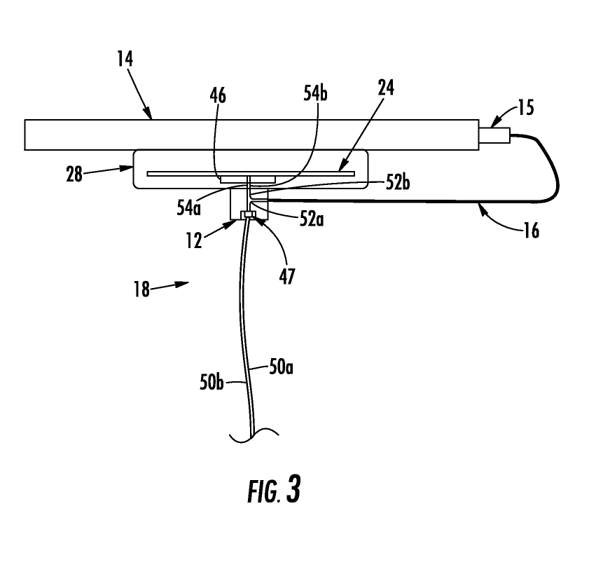

The base 18 may be configured to be supported on a fixed support surface 44, such as a counter, shelf, fixture, or the like. Thus, the base 18 may be located entirely above the support surface 44. The base 18 may be secured to the support surface 44 using any desired technique such as an adhesive and/or fasteners. The base 18 may include a recoiler 22 as discussed above. As such, the cable 20 may be extended from the base 18 when the sensor 12 and the item of merchandise 14 are lifted from the base, and the cable may be retracted into the base when the sensor and the item of merchandise are returned to the base. The recoiler 22 may be spring biased in some embodiments such that the cable 20 is automatically retracted within the base 18. FIG. 1 shows that the recoiler 22 is disposed within the base 18, while FIG. 2 shows that the base may be supported on the support surface 44, while the recoiler may be positioned below the support surface. Furthermore, the base 18 may include a PCB 32, circuitry, or the like that is in electrical communication with the cable 20. In this regard, the cable 20 may include one or more electrical conductors 50a, 50b (see, e.g., FIG. 3) extending along the length of the cable. In some cases, the cable 20 may include a pair of conductors 50a, 50b for defining a sense loop or circuit and conducting an electrical signal. In other cases, the cable 20 may include a single conductor, such as an electrical conductor, or optical conductor for conducting an optical signal (e.g., a fiber optic cable).

The base 18 may further include an alarm mechanism 34, such as a piezoelectric transducer, for generating an audible alarm in response to a security event. The base 18 may also include a battery 31 that is in electrical communication with the PCB 32. The base 18 may include a port 36 that is configured to facilitate communication with a key 39. For example, the port 36 may facilitate wireless communication with a key 39 for arming or disarming the security system 10. In one embodiment, the key 39 is an infrared key configured to arm/disarm the alarm mechanism 34 with a unique identifying code. In some embodiments, the key 39 is similar to the IR and IR2 keys manufactured by InVue Security Products Inc. The base 18 may include a switch 38 (e.g., a plunger switch) that is configured to detect when the base is removed from the support surface 44 in an unauthorized manner.

The base 18 may be electrically connected to a power source 42 which is configured to provide power to the base. The power source 42 may include a connector at a free end (e.g., a USB or like plug). The base 18 may be configured to facilitate power transfer from the external source of power to the cable 20 and to item of merchandise 14, as explained in further detail below. Therefore, the item of merchandise 14 may be powered by power transferred thereto and may be used to charge a battery associated with the item of merchandise.

A separate lock mechanism 48 may be disposed within the base 18 for locking the base to the sensor 12 to prevent the sensor and item of merchandise 14 from being lifted from the base. For example, a fastener may be used to secure the base 18 to the sensor 12. Such a lock mechanism 48 may be employed after hours in a retail environment to prevent unauthorized removal and further security of the security system 10, as the cable 20 will be inaccessible. It is also understood that the lock mechanism 48 could incorporate electro-mechanical means for locking the sensor 12 to the base 18. In one example, the lock mechanism 48 could be actuated in response to communication with a key 39.

An end of cable 20 may be secured to the sensor 12. In one example, the cable 20 may be attached to the sensor 12 with a swivel 47 or like connector to allow for rotational movement between the sensor and the cable. The swivel 47 could be permanently attached to the sensor 12 or could be removably attached if desired. In one example, the cable 20 is hardwired into the sensor 12. Likewise, an end of the adapter cable 16 may be secured to the sensor 12. For instance, the adapter cable 16 may be hardwired to the sensor 12 or permanently attached with a connector, although the sensor could be removably attached with a connector if desired.

It is understood that the cable 20 and adapter cable 16 may be any suitable cord, tether, or the like. In addition, the cables 16, 20 may include one or more electrical conductors 50a, 50b, 52a, 52b for transmitting electrical, security, and/or communication signals. In addition, the cables 16, 20 may be a single strand, multi-strand, or braided. The cable 20 may be flexible to facilitate extension and retraction within the base 18, and in some embodiments, may be formed of a cut-resistant material. Furthermore, the cables 16, 20 may have various cross sections, such as round or flat. In some embodiments, the security system 10 may not include a recoiler 22. Thus, the cable 20 could be a straight or coiled cable that is secured to the sensor 12 at one end and electrically connected to a base 18 or other device at an opposite end.

Various sensing techniques may be employed for determining whether the cable 20 and/or adapter cable 16 has been cut or removed from the sensor 12 in an unauthorized manner. For example, the cables 16, 20 may each include a pair of electrical conductors 50a, 50b, 52a, 52b that define a sense loop therethrough. Thus, should the sense loop be interrupted (e.g., by cutting or shorting the cable), the PCB 32 in the base 18 may detect the interruption and generate an alarm signal (e.g., an audible and/or a visible alarm).

Voltage adaption may be needed in order to accommodate different items of merchandise 14 that require different operating voltages. The voltage adapter 28 may include a regulator 46 to carry out such voltage adaption of power input from the power source 42. Thus, power provided from the power source 42 may be transferred through the cable 20 and to the voltage adapter 28 where the regulator 46 may convert the output voltage appropriate for the item of merchandise 14. The voltage adapter 28 may be “modular” in that the voltage adapter may be removably attachable to the sensor 12. The voltage adapter 28 may be attached to the sensor 12 in a variety of manners, such as with one or more fasteners, adhesive, friction fit, snap fit, twist fit, or the like. The sensor 12 may be sized and configured to accommodate a variety of different voltage adapters 28. For instance, different voltage adapters 28 may be used for different types of items of merchandise 14. In one embodiment, a larger voltage adapter 28 may be used for a larger item of merchandise 14 than another voltage adapter that may be used for a smaller item of merchandise. In another embodiment, the voltage adapters 28 may differ in that they may be configured to output different voltages depending on the requirements of a particular item of merchandise 14. In addition, the voltage adapters 28 may differ depending on the degree of security sensing desired. For example, the voltage adapter 28 may include an alarm mechanism, battery, and/or a switch 33 (e.g., a plunger switch) that is configured to detect when the item of merchandise 14 is removed from the voltage regulator in an unauthorized manner. Therefore, a variety of different modular voltage adapters 28 may be used with a common sensor 12 for use with different items of merchandise 14. It is understood that the voltage adapter 28 and/or sensor 12 may also or alternatively include a switch (e.g., a plunger switch) for detecting removal of the voltage adapter from the sensor in an unauthorized manner.

The modularity of the voltage adapter 28 allows for convenient removal of the voltage adapter and the item of merchandise 14 by authorized personnel for daily removal purposes or for relocating an item of merchandise to another display location. Moreover, the modularity of the voltage adapter 28 allows the sensor 12 to be of smaller size, such as for fitting through an opening 45 defined in the support surface 44. For instance, as shown in FIG. 2, the recoiler 22 may be positioned below the support surface 44, while the base 18 may be supported on the support surface. Thus, a larger opening is not required to pass the voltage adapter through the support surface.

In some cases, the sensor 12, adapter cable 16, and cable 20 may make up an assembly. In this regard, the adapter cable 16 and cable 20 may be attached to the sensor 12 (e.g., via hardwiring) such that the cables may not be removed without damaging the sensor and/or the cables. Different assemblies may be employed for different items of merchandise 14. For example, the assemblies may differ in the type of connector 15 employed for different items of merchandise requiring different connector types. Because the adapter cables 16 may be prone to theft or unauthorized removal, such an assembly reduces the incidence that the adapter cable will be removed from the sensor 12, whether inadvertently or by a thief. The assemblies could also differ in that the assembly may or may not include a recoiler 22. Thus, different assemblies may be provided depending on whether a recoiler 22 is provided. In addition, the assembly may be replaceable should any cable 16, 20 or sensor 12 malfunction or be damaged. For instance, the recoiler 22 may also be provided with the assembly, such that the recoiler may be replaced as needed. Where the recoiler 22 is positioned within a base 18, the recoiler may be removable for facilitating ready replacement.

FIG. 3 shows an enlarged view of the voltage adapter 28 and sensor 12. In this embodiment, the cable 20 includes a pair of conductors 50a, 50b. Likewise, the adapter cable 16 includes a pair of conductors 52a, 52b. One of the conductors 50a is directly and electrically connected to one of the conductors 52a. The other conductor 50b of the cable 20 is not directly connected to the other conductor 52b of the adapter cable 16. As shown in FIG. 3, the voltage adapter 28 includes a pair of conductors 54a, 54b or contacts. Each of the conductors 54a, 54b are configured to electrically connect to a respective conductor 50b, 52b of the cable 20 and adapter cable 16, respectively. Thus, attaching the voltage adapter 28 to the sensor 12 results in an electrical connection between the cable 20 and the adapter cable 16. It follows that when the voltage adapter 28 is removed from the sensor 12, the cable 20 and adapter cable 16 are not electrically connected to one another. The electrical connection between the voltage adapter 28 and the sensor 12 may occur in any desired manner, such as via electrical contacts on each of the voltage adapter and the sensor, wherein the electrical contacts on the sensor are electrically connected to the conductors 50b, 52b. Alternatively, the sensor 12 and/or voltage adapter 28 may include a male/female connector that engages one another. Furthermore, it is understood that the sensor 12 may likewise include one or more conductors or contacts for facilitating an electrical connection between the cable 20 and adapter cable 16 and between the cables 16, 20 and the voltage adapter 28.

The foregoing has described one or more embodiments of security systems for securing an item of merchandise from theft or unauthorized removal. Although various embodiments of the present invention have been shown and described, it will be apparent to those skilled in the art that various modifications thereto can be made without departing from the spirit and scope of the invention. Accordingly, the foregoing description is provided for the purpose of illustration only, and not for the purpose of limitation.

That which is claimed is:

1. A security system for securing an item of merchandise from theft, comprising:
a sensor;
a first cable connected to the sensor;
a second cable connected to the sensor and configured to removably engage the item of merchandise; and
a voltage regulator configured to be removably attached to the sensor and the item of merchandise,
wherein the voltage regulator is configured to be electrically connected to each of the first and second cables and to adapt voltage provided to the item of merchandise through the second cable.

2. The security system of claim 1, wherein one end of the first cable comprises a swivel operably engaged with the sensor such that the sensor is configured to rotate relative to the first cable.

3. The security system of claim 1, wherein one end of the second cable is hardwired to the sensor and an opposite end comprises a connector for removably engaging the item of merchandise.

4. The security system of claim 1, wherein the first and second cables are configured to be electrically connected via the voltage regulator.

5. The security system of claim 1, wherein the voltage regulator comprises a pressure switch that is configured to engage the item of merchandise and to detect when the item of merchandise is removed from the voltage regulator in an unauthorized manner.

6. The security system of claim 1, further comprising a base configured to removably support the sensor and the item of merchandise thereon.

7. The security system of claim 6, further comprising a recoiler connected to an end of the first cable, wherein the recoiler is configured to allow the cable to be extended and retracted relative to the base.

8. The security system of claim 6, wherein the base further comprises a lock mechanism configured to lock the base to the sensor.

9. The security system of claim 6, wherein one end of the first cable is connected to the sensor and the opposite end is connected to the base.

10. The security system of claim 1, wherein the first cable and/or the second cable comprises a plurality of electrical conductors for defining a sense loop.

11. The security system of claim 10, further comprising an alarm mechanism configured to generate an alarm signal when the item of merchandise is removed from the voltage regulator or the sense loop is interrupted.

12. The security system of claim 1, wherein the first cable is configured to transmit power to the voltage regulator to be adapted prior to transmitting the power through the second cable.

13. The security system of claim 1, wherein the voltage regulator comprises an adhesive for attachment to the item of merchandise.

14. The security system of claim 1, wherein each of the first and second cables comprises at least one conductor, and wherein the voltage regulator is configured to be electrically connected to each of the at least one conductors when attached to the sensor.

15. A security system for securing an item of merchandise from theft, comprising:
at least one sensor assembly comprising:
a sensor;
a first cable connected to the sensor; and
a second cable connected to the sensor and configured to removably engage the item of merchandise; and
a modular voltage regulator selected from a plurality of different modular voltage regulators, each modular voltage regulator configured to be removably attached to the sensor and the item of merchandise,
wherein the voltage regulator is configured to adapt voltage provided to the item of merchandise through the second cable.

16. The security system of claim 15, wherein the plurality of different modular voltage regulators are configured to provide a different output voltage.

17. The security system of claim 15, wherein the plurality of different modular voltage regulators are of different size.

18. The security system of claim 15, wherein the sensor assembly is selected from a plurality of different sensor assemblies, wherein each modular voltage regulator is configured to be removably attached to the item of merchandise and the sensor of each of the plurality of different sensor assemblies.

19. The security system of claim 18, wherein each of the plurality of different sensor assemblies comprises a different type of connector for removably engaging the item of merchandise.

20. A method for securing an item of merchandise from theft comprising:
providing a sensor having a first cable and a second cable;
attaching a voltage regulator to the sensor and the item of merchandise, the voltage regulator configured to adapt voltage provided to the item of merchandise through the second cable; and
connecting the second cable to the item of merchandise.
